(19) United States
(12) Patent Application Publication
(10) Pub. No.: US 2026/0100067 A1
(43) Pub. Date: Apr. 9, 2026

(54) LINE LOCATION AND CHARACTER IDENTIFICATION TECHNIQUES FOR OPTICAL CHARACTER RECOGNITION

(71) Applicant: Capital One Financial Corporation, McLean, VA (US)

(72) Inventors: Keith Smith, Raleigh, NC (US); Evan Kountouris, Raleigh, NC (US); Robert del Prado, Los Angeles, CA (US); Daniel A. Gisolfi, Hopewell Junction, NY (US)

(21) Appl. No.: 18/907,216

(22) Filed: Oct. 4, 2024

(51) Int. Cl. G06V 30/244; G06V 30/18; G06V 30/182

(52) U.S. Cl. CPC G06V 30/245; G06V 30/18019; G06V 30/182

(57) ABSTRACT

Techniques for recognizing characters in an image of a physical artifact may involve identifying contours in the image and sorting identified contours into different groups. A first group of contours may be analyzed to locate an array of lines in the image of the bank check. Locating each line in the line array may involve processing image data to allocate each contour in the first group to a particular line. After the array of lines is located, a second group of contours that each intersects a line may be analyzed. Any portions of each of the second group of contours that fit within upper and lower boundaries of a given line are added to the given line. After processing the first and second groups of contours, contours within a given line are analyzed to determine any individual identifiable characters. Each character may then be analyzed for character recognition.

### BACKGROUND

In today's digital age, many tasks that were traditionally performed manually are performed electronically. Modern consumers expect to be able to perform these types of tasks in an accessible and convenient way, such as via a smartphone device, which has led to development of software applications that facilitate performance of various tasks, including capturing images of physical data and extracting information from images of scanned data. Given the quick rise in consumer demands, there is a need for improved technology for electronically extracting information from images of data.

### OVERVIEW

Disclosed herein is new software technology related to recognizing characters in an image of a physical artifact (e.g., a document, a bank check, etc.). In one implementation, the disclosed software technology may involve three stages: (i) line location, (ii) character location, and (iii) character recognition.

In one aspect, the disclosed technology may take the form of a method to be carried out by a computing platform that involves (i) receiving, from a computing device associated with a given user, image data corresponding to an image of a physical artifact, (ii) analyzing the image data to identify contours present in the image, (iii) sorting the contours into mutually exclusive groups, wherein a first group of contours is discarded from further analysis;, (iv) evaluating a second group of contours and thereby identifying respective locations of lines in an array of lines in the image, wherein each line comprises a respective set of contours from the second group of contours that have a similar y-axis value within the image, (v) evaluating a third group of contours and thereby adding additional contours to the array of lines, wherein each contour in the third group intersects a given line in the array of lines, (vi) for each line in the array of lines, grouping the line's respective set of contours into individual characters, and (vii) applying one or more character recognition techniques and thereby output a recognized character for each individual character in each line.

In one example, the image may be captured using a camera of the computing device. In another example where the image is captured using a camera of the computing device, the physical artifact may comprise a physical bank check.

In an example, analyzing the image data to identify contours present in the image may comprise identifying each continuous set of pixels in the image data as a respective contour.

In an example, sorting the contours into mutually exclusive groups may comprise (i) establishing a contour size baseline comprising a minimum size threshold and a maximum size threshold, (ii) identifying contours that do not meet minimum size threshold as the first group of contours, (iii) identifying contours that fall within the minimum size threshold and the maximum size threshold as the second group of contours, and (iv) identifying contours that exceed the maximum size threshold as the third group of contours.

In an example, the minimum size threshold may comprise a minimum possible size of any given contour for a given character font presented in the physical artifact.

In an example, the maximum size threshold may comprise a maximum possible size of any given contour for a given character font presented in the physical artifact.

In an example, evaluating the second group of contours and thereby identifying the respective locations of each of the array of lines in the image may involve (1) scanning the image from a first edge to a second edge, and (2) while scanning the image, (i) identifying a first contour, (ii) drawing a first bounding box enclosing the first contour and thereby locating a first line comprising the first contour, (iii) identifying an additional contour, (iv) drawing a projected box enclosing the additional contour, wherein the projected box is extended vertically around the additional contour by a threshold amount, and (v) extending the projected box laterally in a left-ward direct to identify any preceding contours having a respective line to which the additional contour may be added.

In an example, the method may further involve: (1) after identifying the additional contour, while extending the projected box laterally, determining that the projected box overlaps the first bounding box enclosing the first contour, (2) based on determining that the projected box overlaps the first bounding box enclosing the first contour, determining that the additional contour is to be added to the first line, and (3) adding the additional contour to the first line. In one embodiment, the method may further involve (1) after identifying the additional contour, while extending the projected box laterally, determining that the projected box overlaps (i) the first bounding box enclosing the first contour and (i) a second bounding box enclosing a second contour in a second line, (2) based on one or both of (i) a respective amount of overlap between the projected box and each of the first and second contours or (ii) a respective proximity between the additional contour and each of the first and second contours, determining that the additional contour is to be added to the second line instead of the first line, and (3) adding the additional contour to the first line.

In an example, evaluating the third group of contours and thereby adding additional contours to the array of lines may comprise, for each contour in the third group that intersects a given line in the array of lines, (i) determining at least one of a first portion that extends vertically beyond an upper boundary of the given line or a second portion that extends vertically beyond a lower boundary of the given line, (ii) determining a third portion that fits within the upper and lower boundaries of the given line, (iii) discarding the first and second portions, and (iv) adding the third portion to the given line.

In an example, grouping the line's respective set of contours into individual characters may comprise, for each line in the line array, (i) beginning scanning the line, (ii) identifying a beginning of the first contour in the respective set, (iii) based on identifying the beginning of the first contour, begin adding the first contour to a buffer, and (iv) identifying an end of the first contour. In one embodiment, the example method may further comprise (v) making a first determination that the end of the first contour is reached and a minimum character area has not been reached, (vi) based on the first determination, making a second determination that the first contour is to be grouped as an individual character, and (vi) based on the second determination: (1) drawing a bounding box enclosing the first contour, (2) clearing the buffer, and (3) continuing scanning the line. In another embodiment, the example method may further comprise (v) making a first determination that the end of the first contour is reached and the minimum character area has not been reached, (vi) based on the first determination, continuing scanning the line, (vii) identifying a beginning of a second contour in the respective set, (viii) make a second determination that the minimum character area has not been reached and a maximum contour distance has not been reached; (ix) based on the second determination, beginning adding the second contour to the buffer, (x) while scanning the second contour, making a third determination that the minimum character area has been reached and the maximum contour distance has not been reached, (xi) based on the third determination, making a fourth determination that that the first contour and the second contour are to be grouped as an individual character, and (xii) based on the fourth determination: (1) drawing a bounding box enclosing the first and second contours; (2) clearing the buffer, and (3) continuing scanning the line.

In another aspect, disclosed herein is a computing platform that includes a communication interface, at least one processor, at least one non-transitory computer-readable medium, and program instructions stored on the at least one non-transitory computer-readable medium that are executable by the at least one processor to cause the computing platform to carry out the functions disclosed herein, including but not limited to the functions of the foregoing methods.

In yet another aspect, disclosed herein is a non-transitory computer-readable medium provisioned with program instructions that, when executed by at least one processor, cause a computing platform to carry out the functions disclosed herein, including but not limited to the functions of the foregoing methods.

One of ordinary skill in the art will appreciate these as well as numerous other aspects in reading the following disclosure.

### BRIEF DESCRIPTION OF THE DRAWINGS

FIG. 1 depicts an example bank check including a MICR line and a consumer signature that overlaps the MICR line.

FIG. 2 depicts an example scanned image of a bank check including a curved MICR line and a consumer signature that overlaps the curved MICR line.

FIG. 3 depicts example characters that may be included in a MICR line of a bank check.

FIG. 4 depicts an example computing environment in which the disclosed functionality may be implemented.

FIGS. 5A, 5B, and 5C depict examples of locating lines and allocating contours to respective lines according to the disclosed software technology.

FIGS. 6A and 6B depict additional examples of locating lines and allocating contours to respective lines according to the disclosed software technology.

FIGS. 7A, 7B, and 7C depict examples of processing large contours according to the disclosed software technology.

FIG. 8 depicts an example of a line produced as a result of performing medium and large contour processing according to the disclosed software technology.

FIGS. 9A and 9B depict examples of scanning and grouping contours within a line into individual characters according to the disclosed software technology.

FIG. 10 depicts a flow diagram of example functionality that may be carried out for processing a scanned image in accordance with aspects of the disclosed technology.

FIG. 11 depicts a structural diagram of an example back-end computing platform that may be configured to carry out back-end computing platform functionality according to the disclosed software technology.

FIG. 12 depicts a structural diagram of an example end-user device that may be configured to carry out end-user device functionality according to the disclosed software technology.

The following disclosure makes reference to the accompanying figures and several example embodiments. One of ordinary skill in the art should understand that such references are for the purpose of explanation only and are therefore not meant to be limiting. Part or all of the disclosed systems, devices, and methods may be rearranged, combined, added to, and/or removed in a variety of manners, each of which is contemplated herein.

### DETAILED DESCRIPTION

Optical character recognition (OCR)—the process of converting images of handwritten, printed, or typed text into machine-encoded text—has become a prevalent means of extracting information in today's digital world. OCR is used across industries and in many aspects of daily life, including, as some examples, business practices, banking procedures, academia, and even personal tasks. Widespread usage of OCR has prompted developments in OCR technology. However, some shortcomings in existing OCR technology remain for certain more challenging character recognition scenarios.

For instance, existing OCR technology has trouble processing non-linear lines of characters, differentiating overlaps between handwritten and printed text, recognizing characters with multiple contours, and handling different font sizes. Shortcomings such as these can lead to inaccurate character identification, which can be problematic for a variety of reasons.

One example area where shortcomings in existing OCR technology can be particularly problematic is online banking. The advent of online banking in recent years has led to an increase in electronic deposits of physical bank checks via banking applications (e.g., using a smartphone camera). In general, OCR is used to extract banking and routing information from physical bank checks in order to facilitate the transfer of funds from financial accounts. In this respect, a bank check typically includes a “MICR” line (i.e., “magnetic ink character recognition” line) comprising characters that collectively indicate a bank routing number, a check number, and a customer account number. In accordance with banking industry standards, MICR lines are printed on bank checks traditionally using magnetic ink (or toner) that enable a computing device (e.g. a check reading device) to scan the physical bank check and not only read the characters in the MICR line but also differentiate the MICR characters from any other markings made with non-magnetic ink, such as handwritten or stamped markings, that may overlap the MICR characters.

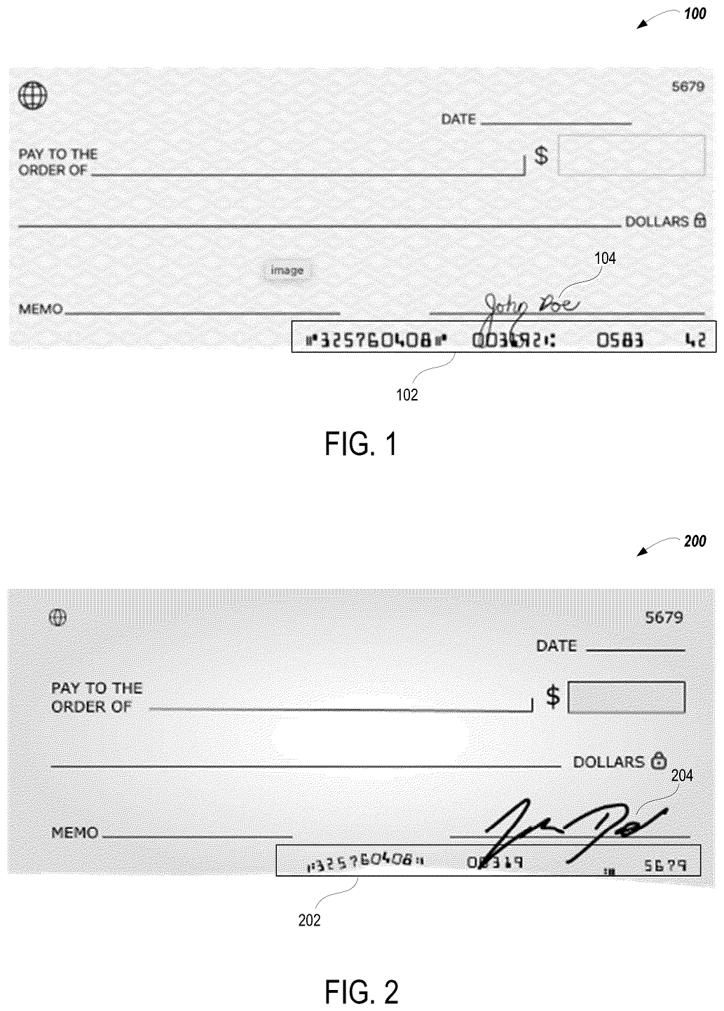

Turning now to FIG. 1, an example bank check 100 including an example MICR line 102 is depicted. The MICR line 102 may be printed using magnetic ink and may indicate information including a routing number and an account number for facilitating the transfer of funds from a financial institution and account associated with the routing and account numbers indicated on the check. As shown in FIG. 1, a signature 104 may overlap the MICR line 102 in some situations. In accordance with the discussion above, a check reading device that functions to scan the physical check 100 and read the MICR line 102 using OCR technology may differentiate between the overlapping text of the MICR line 102 and the signature 104 based on the magnetic ink of the MICR line 102, thereby enabling the characters of the MICR line 102 to be accurately recognized despite the overlap.

However, the benefit of magnetic ink has been reduced with the advent of online banking, where bank checks are often deposited using a smartphone camera that captures an image of the check, which is then processed and deposited via a mobile banking application (e.g., in combination with one or more back-end computing platforms). This practice may generally be referred to herein as a “mobile deposit.” Accordingly, a scanned image of the bank check, rather than the physical check itself, is used to interpret the characters of the MICR line. In this regard, scanned images of bank checks can include some or all of the challenging character recognition scenarios mentioned above that are difficult for existing OCR technology to handle, but do not benefit from the magnetic ink on the physical bank check.

Consider the example shown in FIG. 2, which depicts a scanned image 200 of a bank check that includes one or more character recognition scenarios that are difficult to process using existing OCR technology. As one example, the scanned image 200 includes a MICR line 202 that appears to be curved. In practice, the scanned image 200 may have been captured by a consumer via a software banking application using a camera of a computing device such as a smartphone or tablet during the process of completing a mobile deposit of the bank check. However, the bank check may not have been completely flat at the time the scanned image 200 was captured. For instance, in practice, consumers often place bank checks on any readily accessible surface when completing a mobile deposit, and the surface may not be flat (e.g., a consumer's lap, a pillow, a carpet, etc.). Further, regardless of the surface on which they are placed, bank checks are often not flat themselves, as consumers tend to store them in a folded (or otherwise uneven) state until they are able to complete the mobile deposit. Thus, the bank check may be curved or in an otherwise non-flat position when a scanned image of the bank check is captured, resulting in a curvature in the scanned image of the bank check. As shown in FIG. 2, the MICR line 202 is curved such that some of the characters are askew and are not arranged linearly, which makes it difficult to identify the characters in the MICR line 202 using existing OCR technology. As another example, the scanned image 200 includes a consumer signature 204 that overlaps a section of the MICR line 202. Because mobile deposits do not utilize magnetic ink readers, it is difficult to differentiate between the signature 204 and the MICR line 202 and identify the characters in the MICR line 202 using existing OCR technology.

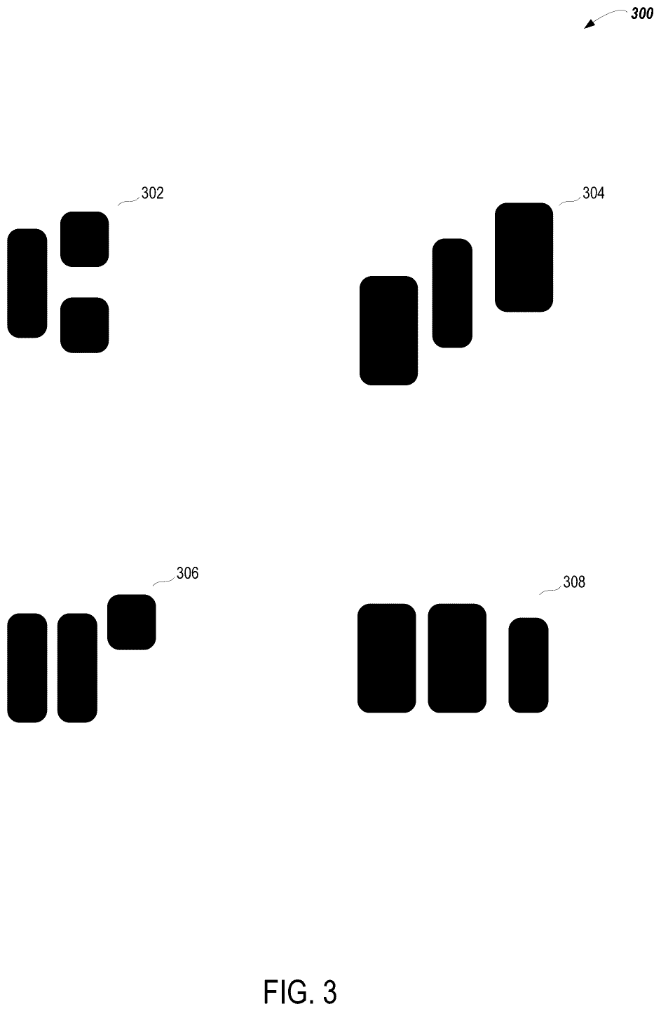

In addition to scenarios such as curvatures and overlaps, character recognition for mobile deposits of bank checks can be challenging using existing OCR technology because in addition to numerical characters, a MICR line includes certain special banking-specific characters. These special characters include a “transit” character, an “on-us” character, an “amount” character, and a “dash” character, which may be collectively referred to as “TOAD” characters. The TOAD characters delineate various parts of the MICR line and are particularly challenging to deal with for existing OCR technology because each of the TOAD characters is formed by a set of disconnected “contours,” unlike the traditional 0-9 numerals which are each comprised of continuous contours. As referred to herein, a “contour” may be defined by a set of continuous pixels. FIG. 3 depicts each of the TOAD characters. The “transit” character 302 indicates a routing number. The “on-us” character 304 indicates either (i) a check number if it precedes a numerical character or (ii) an account number if it does not precede a numerical character. The “amount” character 306 indicates a transaction amount. The “dash” character indicates either a routing number or a destination account number.

As mentioned above, mobile deposit of a bank check does not benefit from the traditional advantages of magnetic ink in MICR line character recognition, as it involves an image of the bank check that has been captured with a consumer's computing device camera via a banking software application, which is typically reduced to black-and-white pixels, which is then processed for OCR. However, existing OCR technology has difficulty processing such images for the various reasons discussed above, which could lead to inaccurate identification of characters in the MICR line, which in turn can lead to undesired outcomes such as delayed deposit of funds or funds being withdrawn from an incorrect account, among other possibilities.

To address these and other problems with existing OCR technology, disclosed herein is new software technology that involves new techniques related to recognizing characters in an image of a physical artifact (e.g., a document, a bank check, etc.). In the examples below, the disclosed software technology will be described in the context of evaluating scanned bank checks, but it should be understood that the disclosed software technology can be utilized to recognize characters in other situations as well that include one or more of the problematic scenarios mentioned above (e.g., curvatures, overlaps, etc.). Some nonlimiting examples of such situations may include text that has been stamped (e.g., stamped ink on printed ink) or text that has been annotated (e.g., handwritten annotations on printed text), among other possibilities.

At a high level, the disclosed functionality may involve three stages: (i) line location, (ii) character location, and (iii) character recognition. Each of these stages will be described in more detail further below. In the examples below, the disclosed functionality may be discussed in the context of an image of a bank check that has been captured for mobile deposit and may reference the example scanned image 200 shown in FIG. 2, for purposes of illustration.

In general, the “line location” stage of the disclosed software technology may involve processing an image of a physical artifact to identify each contour (i.e., a set of continuous pixels) in the image, locating each “line” in the image, and allocating each contour to a respective line. As described herein, a “line” may comprise a group of contours having a similar axis value along an x-axis (e.g., for vertical script) or a y-axis (e.g., for horizontal script) in the scanned image.

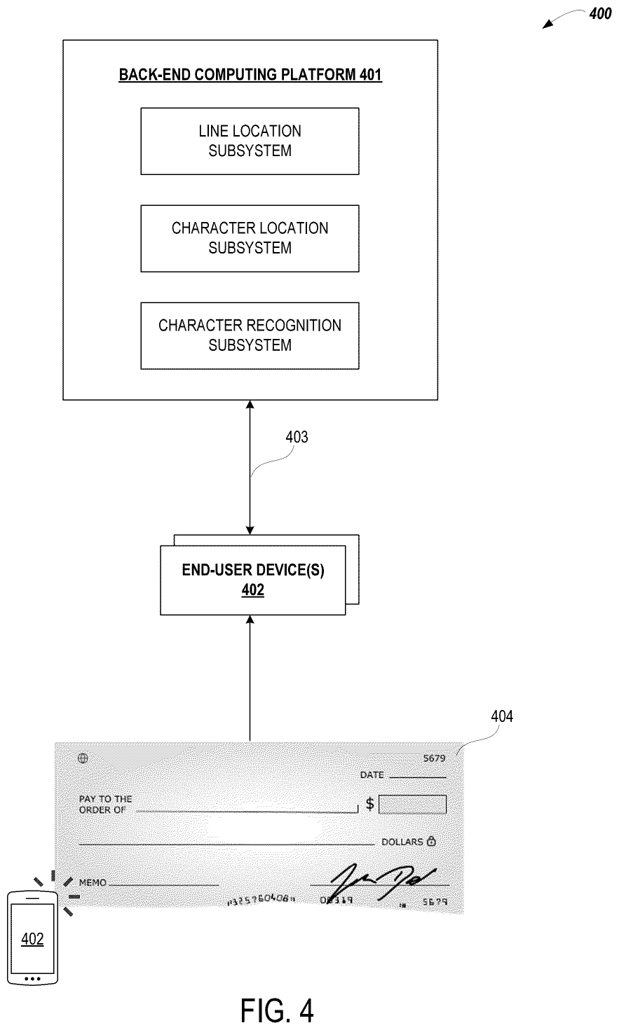

FIG. 4 depicts an example computing environment 400 in which example embodiments of the disclosed technology may be implemented. The computing environment 400 may include an example back-end computing platform 401 that is configured to carry out some or all of the functions discussed below, including any of the back-end platform functionality disclosed herein. In one implementation, as shown in FIG. 4, the back-end computing platform 401 may comprise one or more software subsystems, such as a line location subsystem, a character location subsystem, and a character recognition subsystem, that each function to perform certain functionality as disclosed herein. The back-end computing platform 401 may communicate with one or more computing devices, such as one or more end-user devices 402, via respective communication paths 403. The one or more end-user devices 402 may be configured to carry out some or all of the functions discussed below, including any of the end-user device functionality disclosed herein.

In the examples discussed below, the back-end computing platform 401 may communicate with an end-user device 402, such as a smartphone, to receive image data corresponding to a scanned image of an artifact, such as the scanned image 404 of a physical bank check, captured by the end-user device 402.

In practice, the scanned image of the artifact may be captured by a camera of an end-user device 402. For instance, an image of a physical bank check may be captured by a camera of a consumer's smartphone during the process of conducting a mobile deposit of the bank check via a banking software application. Further, one or more skew and/or slant correction techniques may be applied to the image before the image is processed in accordance with the techniques disclosed herein.

After the image of the bank check has been captured, the disclosed functionality may proceed with the line location stage, which may begin with obtaining image data for the image. As discussed above, the image data may take the form of black-and-white pixel data corresponding to the captured image. For instance, the image data corresponding to the scanned image 404 may indicate markings present on the bank check.

After the end-user device 402 obtains the image data, it may transmit the image data to the back-end computing platform 401 to be analyzed. As an initial step, the back-end computing platform 401 may identify all contours in the image. As noted above, a contour comprises a continuous set of pixels. Thus, each continuous set of pixels may indicate a respective contour. The back-end computing platform 401 may then sort the identified contours according to size. Sorting the identified contours by size may take various forms.

In one implementation, the back-end computing platform 401 may sort the identified contours into small, medium, and large-sized contour groups. In this respect, each group size may be determined by establishing a contour size baseline based on which a respective size of each contour in the image of the bank check can be determined. Establishing the contour size baseline may take various forms. In one embodiment, establishing the contour size baseline may involve performing a coarse character recognition of an individual character from the MICR line. MICR characters are printed using standardized MICR fonts that have standardized sizes for each MICR character, and the contours within each character, which enables a maximum and minimum area for a given size group to be established. In this respect, a given area of the image where the MICR line is expected to be located may be scanned for character analysis, based on which a given MICR character may be identified and recognized for establishing a baseline contour size. For instance, MICR lines are typically located toward the bottom portion of a bank check. Thus, the bottom section of the image may be scanned first to identify a MICR character that is not subject to one or more of the challenging character recognition scenarios mentioned above, using standard OCR technology. For instance, the given MICR character may comprise a numeral from 0-9. In any event, because MICR fonts are standardized, the size of the given MICR character—i.e., an area comprising the given MICR character defined by pixels—may be used to derive a size range based on which contours in the image are to be sorted. For instance, the respective size (i.e., pixel area) of the given MICR character may be used to derive (i) a maximum threshold size that corresponds to a largest-sized contour in the same font as the given MICR character and (ii) a minimum threshold size that corresponds to a smallest-sized contour in the same font as the given MICR character (e.g., the smallest contour that could represent part of a TOAD character).

The maximum and minimum threshold sizes may together be used to establish a baseline contour area based on which identified contours in the image may be sorted. Contours that do not meet the minimum threshold size may be identified as “small” contours and may be discarded from further analysis. For instance, small contours might include specks or other non-substantive markings (also referred to herein as “noise”) that do not represent characters that need to be evaluated (e.g., for completing a mobile deposit). Contours that fall within the minimum and maximum threshold sizes may be identified as “medium” contours and may comprise the first contour group to be processed for line location. Contours that exceed the maximum threshold size may be identified as “large” contours and may be saved for processing after medium contour processing is complete.

After the identified contours have been sorted, the medium contours may be processed to locate each line (i.e., a set of contours having a similar x-axis or y-axis value) in the image of the bank check. The process of locating each line in the captured image of the bank check may take various forms. In one implementation, the process of locating each line may begin by scanning the image data to identify each medium contour in the image and allocating it to a given line. In this respect, the scan may begin from one edge of the image and progress to the other edge of the image, scanning for contours in a single pass. For instance, as one possibility, if the characters in an image belong to a horizontal script that is to be read from left-to-right, the scan may begin at the left edge of the image and progress to the right edge of the image. As another possibility, if the characters in an image belong to a horizontal script that is to be read from right-to-left, the scan may begin at the right edge of the image and progress to the left edge of the image. As yet another possibility, if the characters in an image belong to a horizontal script that is to be read from top-to-bottom, the scan may begin at the top edge of the image and progress to the bottom edge of the image. Other examples are possibility depending on a script to which characters in the image below.

In line with the discussion above, in one embodiment, the scan may begin from the left edge of the image and progress to the right edge. When a first contour is located, a first bounding box may be drawn around the contour, marking the start of a first line, and the scan may progress in a right-ward direction. When a second contour is located, a determination is made as to whether the second contour is part of the first line—i.e., whether or not the second contour has a similar y-axis value as the first contour—or part of a different line. This determination may take various forms.

As one possibility, the determination as to whether the second contour is part of the first line or part of a different line may involve (i) drawing a projected rectangle around the second contour, (ii) extending the projected box vertically—both upward and downward—by a threshold amount that attempts to avoid the location of other contours in other lines that may be in proximity of the second contour, and (iii) extending the projected rectangle laterally in a left-ward direction to locate any end-most contour in a line that has been located along a similar y-axis value. In one embodiment, the threshold amount by which the projected box is extended vertically upward and downward may correspond to an amount that is less than a minimum vertical distance between any two given lines that may be included in a scanned image and greater than a maximum vertical distance between any two contours of a given character (e.g., a TOAD character). In this respect, these maximum and minimum distances may be predetermined or otherwise derived based on image data obtained for the image of the bank check (e.g., based on the baseline contour size discussed above). Other examples are also possible.

While extending the projected rectangle, if a previously-located contour having a similar y-axis value is encountered (e.g., if the previously-located contour intersects the projected rectangle), the back-end computing platform 401 may determine that the second contour is part of the same line as the previously-located contour. Accordingly, the back-end computing platform 401 may add the second contour to the line including the previously-located contour and extend the bounding box defining the line to include the second contour. The scan may then continue to progress in the right-ward direction for locating additional contours and lines.

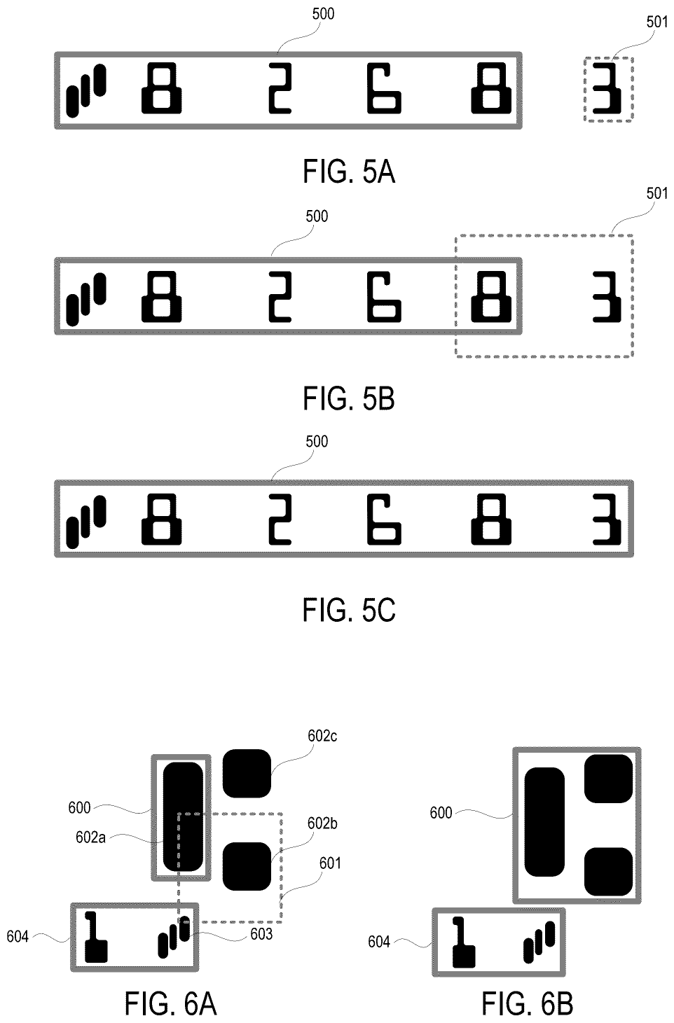

To illustrate with an example, consider FIG. 5A, which includes a line encompassed by a bounding box 500 depicted in a solid outline, comprising five different contours that may have been identified during a scan of a bank check image in accordance with the discussion above. As the scan proceeds in a right-ward direction, a new contour may be located, and a projected rectangle 501, depicted in FIG. 5A by a dashed outline, may be drawn around the new contour. The projected rectangle 501 may be expanded vertically by a threshold amount as described above and then extended in a left-ward direction to locate any other contours with a similar y-axis value. As shown in FIG. 5B, as the projected rectangle 501 is extended laterally, the end-most contour of the line 500, which has a similar y-axis value as the new contour, may be located. As shown in FIG. 5B, the projected rectangle 501 may not encounter any other contours. Thus, the new contour may be added to the line 500 encompassed by the bounding box. As shown in FIG. 5C, the bounding box encompassing the line 500 has been extended to include the new contour, which has been added to the line.

In some instances, it is possible that a projected rectangle for a new contour may identify more than one previously-located contour, each belonging to a respective line to which the new contour may possibly be added. In these situations, the back-end computing platform 401 may make a selection between the previously-located contours and their respective lines based on one or both of (i) a respective percentage of each previously-located contour that is included in the projected rectangle or (ii) a respective proximity of each previously-located contour to the new contour (e.g., based on the shortest distance between contours). For instance, as one possibility, the back-end computing platform 401 may select a given one of the previously-located contours based on the given previously-located contour having a greatest respective percentage included in the projected rectangle. As another possibility, the selection may be made based on the given previously-located contour being the nearest in proximity to the new contour.

To illustrate with an example, consider FIG. 6A, which depicts two lines that have been located during a scan of a bank check image in accordance with the discussion above. A first line enclosed by a bounding box 600 may comprise an end-most contour 602a, and a second line enclosed by a bounding box 604 may comprise an end-most contour 603. As the scan of the image proceeds, a new contour 602b may be identified. In accordance with the discussion above, a projected rectangle 601 may be drawn around the new contour 602b, extended in a vertical direction by a threshold amount, and extended in a lateral direction to identify any previously-located contours having a similar y-axis value. As shown in FIG. 6A, extending the projected rectangle 601 may identify both the contour 602a within line 600 and the contour 603 within the line 604. As noted above, the back-end computing platform 401 may select, from the two candidate lines, a given line to which the new contour 602b should be added. For instance, as one possibility, the given line may be selected based on which one of the contours 602a or 603 has a greater respective percentage included in the projected rectangle 601. As another possibility, the given line may be selected based on which one of the contours 602a or 603 is nearest in proximity to the new contour 602b. In the example of FIG. 6A, the contour 602a may have the greater respective percentage included in the projected rectangle 601 and may also be nearest in proximity to the new contour 602b. Thus, the back-end computing platform 401 may determine that the new contour 602b should be added to the line 600. As shown in FIG. 6B, the contour 602b (along with contour 602c) has been added to the line 600.

In some instances, it is possible that a projected rectangle for a new contour may identify no other previously-located contours (e.g., where the new contour is the first-identified contour along a particular y-axis value). In such instances, the new contour may be determined to be a first contour of a new line, and a new bounding box representing the new line may be drawn around the new contour. The scan may then continue in a right-ward direction as described above to identify additional contours, each of which may be added to an existing line or may start a new line.

As contours are located and added to lines in the image of the bank check and the scan progresses in a right-ward direction, eventually the right edge of the image will be reached. Advantageously, by allocating each contour to a respective line in the manner described above, the disclosed technology reduces the impact of curvatures (e.g., a curved portion of a MICR line as shown in FIG. 2) and similar irregularities in a scanned image that would otherwise be difficult to process using existing OCR technology.

Processing all of the medium contours and allocating each medium contour to a respective line as described above may output a line array for the image, where each line comprises a set of medium contours that have a similar y-axis value. However, one or more lines may have gaps corresponding to large contours that intersect with the one or more lines (e.g., an overlap between a handwritten signature and a portion of the MICR line of the bank check) and were previously identified and reserved for later processing. To fill in these gaps, the large contours may be processed next in order to add any missing contours to one or more lines in the line array. Processing large contours may take various forms.

In one implementation, the functionality of processing large contours may begin by the back-end computing platform 401 identifying large contours that intersect lines that were located in accordance with the discussion above. For each large contour that intersects a given line, any portions of the large contour that extend vertically beyond an upper and a lower boundary of the given line may be discarded, and the remaining portion of the large contour that fits within the boundaries of the given line may be added to the given line.

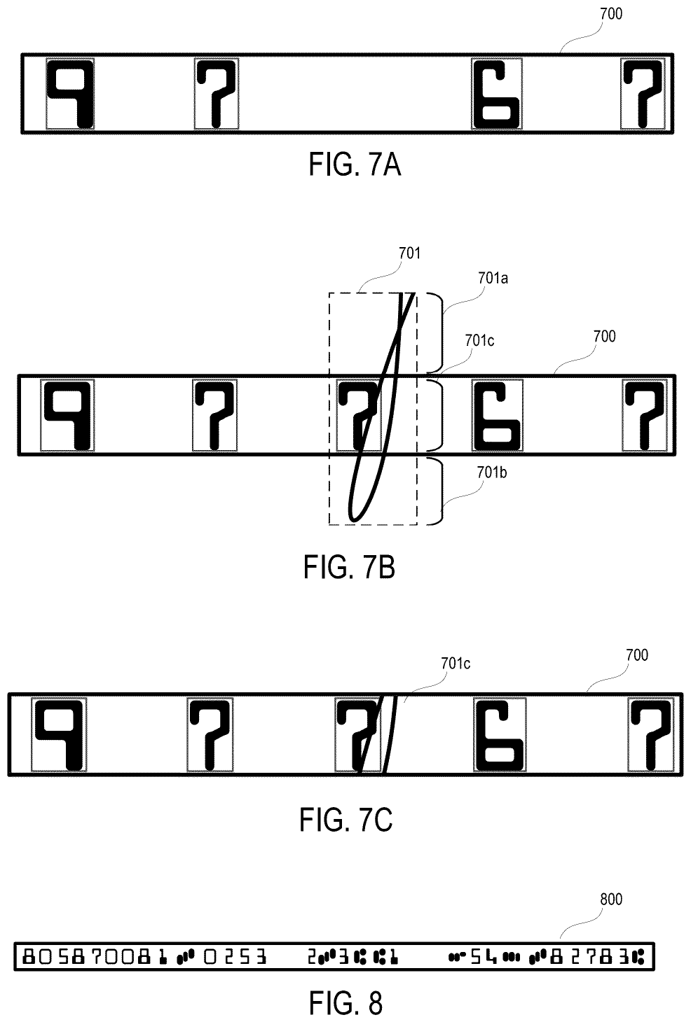

To illustrate with an example, consider FIG. 7A, which depicts a line 700 that may have been located within the scanned image of the bank check 404 in accordance with the discussion above. As shown in FIG. 7A, the line 700 may comprise a set of contours (i.e., a set of medium contours that were determined to be part of the line 700 during medium contour processing). Further, the line 700 may include a gap corresponding to a large contour that intersects the line 700. As noted above, although the back-end computing platform 401 previously identified the large contour during the process of sorting contours by size, the back-end computing platform 401 may have excluded the large contour from the processing of medium contours used to establish line locations, resulting in the gap in line 700 as shown in FIG. 7A.

FIG. 7B depicts a large contour 701 that is determined to intersect with the line 700 during large contour processing (e.g., a signature-character overlap). The large contour 701 may comprise a first portion 701a that extends upward beyond an upper boundary of the line 700, a second portion 701b that extends downward beyond a lower boundary the line 700, and a third portion 701c that fits within the upper and lower boundaries of the line 700. As discussed above, during large contour processing, the portions of the large contour 701 that extend vertically beyond the line 700, such as the portions 701a and 701b, may be discarded. Further, the portion 701c that fits within the boundaries of the line 700 may be added to the line 700. FIG. 7C depicts the line 700 after the large contour 701 has been processed in this way. As shown in FIG. 7C, the portions 701a and 701b of the large contour 701 that intersected the line 700 have been discarded, and the portion 701c has been added to the line 700.

After large contour processing has been completed and any contour gaps within the located lines of the scanned image have been filled in, the resulting output may comprise a set of lines, each comprising a respective set of contours. FIG. 8 depicts one example of a line 800 that the back-end computing platform 401 may produce as a result of performing medium and large contour processing as part of the line location stage of the disclosed functionality.

Advantageously, by processing medium and large contours as described above, the disclosed technology reduces the impact of overlapping text (e.g., a signature overlapping a MICR line) and other similar irregularities in a scanned image that would otherwise be difficult to process using existing OCR technology.

The disclosed functionality may then proceed to the next stage to identify characters based on the contours within each line, which may be referred to as a “character location” stage.

In general, the character location stage of the disclosed software technology may involve processing each line that was identified during the line location stage to group the contours in each line into individual identifiable characters. The individual characters may in turn be processed for character recognition during the “character recognition” stage.

The disclosed functionality for processing a given line to group contours within the given line into individual characters may take various forms. In one implementation, the back-end computing platform 401 may begin by performing a scan of the given line in a right-ward direction to identify a given contour of the line (i.e., a given set of continuous pixels). When the given contour is identified, pixel data corresponding to the given contour may be added to a contour buffer, and the scan may proceed in the right-ward direction. In this respect, the contour buffer may comprise an array of contours that is configured to temporarily store one or more contours associated with a single character. As each given contour is scanned, the pixel data corresponding to the given contour continues to be added to the buffer in order to facilitate a determination as to whether or not the given contour should be identified as an individual character.

When the end of the given contour is reached, the back-end computing platform 401 may determine whether or not the given contour comprises an individual character. For instance, as one possibility, if the end of the given contour is reached and a minimum character area is met, then the given contour may be identified as an individual character. In this respect, as one possibility, a maximum contour area may be established based on an area (e.g., size) of a largest contour in the given line, and the minimum character area may be derived based on a percentage of the maximum contour area. If the given contour is identified as an individual character, a bounding box may be drawn around the given contour, and the contour buffer may be cleared. After the contour buffer is cleared, the scan may then proceed along the given line to group remaining contours in the line into individual characters.

As another possibility, if the end of the given contour is reached and the minimum character area is not met, the scan may proceed in the right-ward direction, continuing to add pixel data to the contour buffer to identify any additional contours that may be grouped with the given contour as part of the same individual character. In this respect, the scan may proceed, and the contour buffer may continue to be populated as long as a maximum distance between contours of a single character has not been reached. In one embodiment, the maximum distance between contours may be established based on the respective widths of the contours within the given line. For instance, a maximum contour width may be determined based on the widest contour in the given line, and the maximum distance between contours may be derived as a percentage of the maximum contour width. The maximum distance between contours may be determined in other ways as well.

For example, if a new contour is identified and the maximum distance between contours has not been reached, pixel data for the new contour may be added to the contour buffer. If the minimum character area still is not met, the scan may continue. As another example, if a new contour is identified and added to the contour buffer, thereby resulting in the minimum character area being met, the contour(s) already in the buffer and the new contour may be grouped together as a single character and enclosed in a bounding box, and the contour buffer may be cleared. After the contour buffer is cleared, the scan may then proceed along the given line to group remaining contours in the line into individual characters.

As yet another example, assume that a given contour that does not meet the minimum character area has been added to the buffer and the scan is proceeding to the right. As the scan proceeds, if the maximum distance between contours is reached and the minimum character area is still not met, the contour buffer may be cleared, and the given contour may be discarded. In this way, any contours included in the line that may comprise non-character markings may advantageously be eliminated prior to character recognition, thereby increasing the accuracy of the character recognition. For instance, returning briefly to FIG. 7C, the line 700 comprises a set of contours including two contours in the portion 701c that were remnants of the signature overlap from the large contour 701 of FIG. 7B. By applying the disclosed functionality for grouping contours within lines into individual characters as described above, these two contours that could otherwise hinder character recognition would effectively be removed, thereby enabling more accurate character recognition of the characters identified in the line 700.

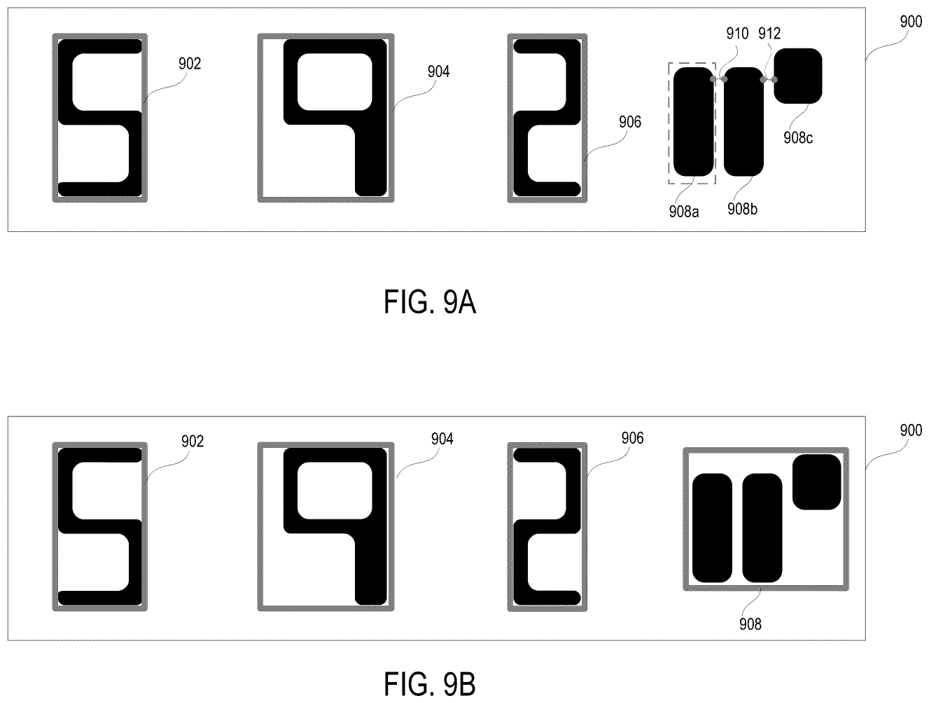

Turning now to FIG. 9A, an example of scanning contours of a line in order to group the contours into individual characters is shown. FIG. 9A depicts a line 900 comprising a first character 902, a second character 904, and a third character 906, each of which the back-end computing platform 401 may have identified in accordance with the character location functionality discussed above. For instance, each of the respective contours of the characters 902, 904, and 906 may have met the minimum character area and thus been identified as an individual character, as indicated by the respective bounding boxes outlining each character. The back-end computing platform 401 may continue to scan the line 900 in a right-ward direction. Based on the scan, the back-end computing platform 401 may identify a contour 908a and may add pixel data for the contour 908a to a contour buffer (not shown). In the example of FIG. 9A, the minimum character area may not be met by the time the end of the contour 908a is reached. Thus, the back-end computing platform 401 may proceed to scan right to identify any other contours in the line 900 that could be grouped with the contour 908a as part of the same character. In turn, the back-end computing platform 401 may identify contour 908b and evaluate a distance 910 between the contours 908a and 908b to determine whether or not it exceeds the maximum distance between contours. In the example of FIG. 9A, the back-end computing platform 401 may determine that the distance 910 does not exceed the maximum contour distance. Further, the back-end computing platform 401 may determine that the minimum character area has also not been met. Thus, the back-end computing platform 401 may add the contour 908b to the buffer and the scan may continue to proceed in a right-ward direction. In turn, the back-end computing platform 401 may identify contour 908c and evaluate a distance 912 between the contours 908b and 908c to determine whether or not it exceeds the maximum distance between contours. In the example of FIG. 9A, the back-end computing platform 401 may determine that the distance 912 does not exceed the maximum contour distance, and thus the back-end computing platform 401 may add the contour 908c to the contour buffer. At this point, the back-end computing platform 401 may determine that the minimum character area has been met. Thus, the back-end computing platform 401 may determine that the three contours 908a, 908b, and 908c are to be grouped together as a single character. As shown in FIG. 9B, the formerly separate contours 908a, 908b, and 908c have been identified as a single character enclosed in a bounding box 908.

Advantageously, by evaluating contours for grouping into individual characters as described above, the disclosed technology increases the likelihood of correctly identifying different types of characters, including characters having more than one contour (e.g., TOAD characters in MICR lines) that would otherwise be difficult to process using existing OCR technology.

In accordance with the discussion above, the character location stage may output, for each line, a set of individual characters that can then be processed for the “character recognition” state.

In the character recognition stage, the disclosed functionality may process each located line in the scanned image to recognize each character in the line that was previously identified during the character location stage. In this respect, the characters in the scanned image may be recognized using any OCR technology now known or later developed. However, in view of the discussion above, first applying the line location and character location functionality as disclosed herein may facilitate more accurate and efficient character recognition by eliminating issues that would otherwise be difficult to handle using existing OCR technology.

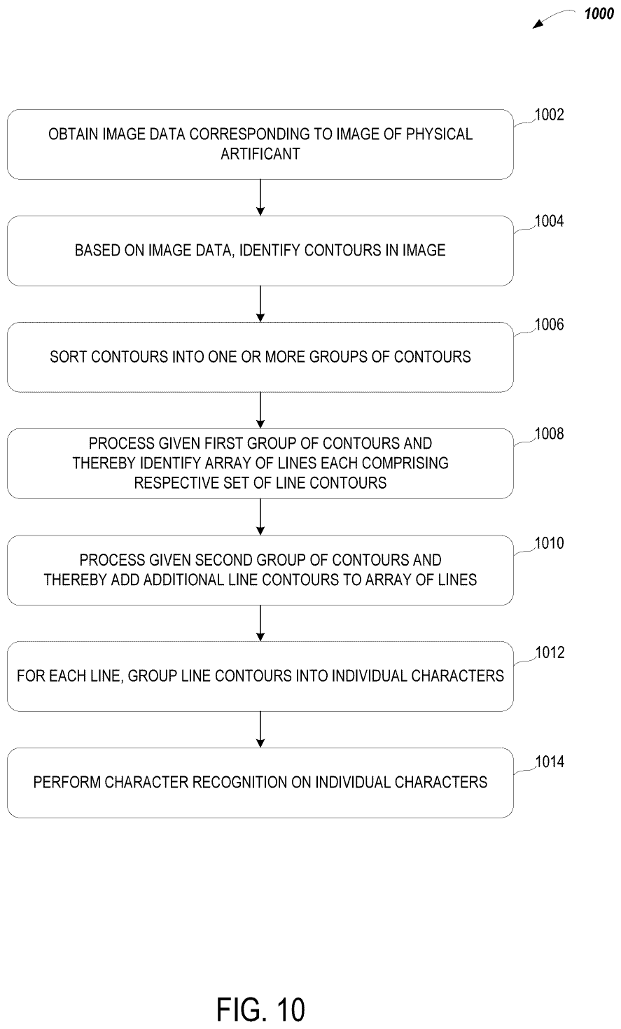

Turning now to FIG. 10, a flow diagram of example functionality 1000 for extracting information from a scanned image of a physical artifact in accordance with the disclosed technology is depicted. In practice, the example functionality 1000 may be carried out by a back-end computing platform that may generally comprise some set of physical computing resources (e.g., processors, data storage, communication interfaces, etc.) that are utilized to implement the new software technology discussed herein. This set of physical computing resources may take any of various forms. As one possibility, the back-end computing platform may comprise cloud computing resources that are supplied by a third-party provider of “on demand” cloud computing resources, such as Amazon Web Services (AWS), Amazon Lambda, Google Cloud Platform (GCP), Microsoft Azure, or the like. As another possibility, the back-end computing platform may comprise “on-premises” computing resources of the organization that operates the back-end computing platform (e.g., organization-owned servers). As yet another possibility, the back-end computing platform may comprise a combination of cloud computing resources and on-premises computing resources. Further, as yet another possibility, the back-end computing platform may comprise one or more dedicated servers that have been provisioned with software for carrying out one or more of the back-end computing platform functions disclosed herein. The one or more computing resources of the back-end computing platform may take various other forms and be arranged in various other manners as well.

The back-end computing platform may be configured to communicate with one or more end-user devices over respective communication paths. The one or more end-user devices may take any of various forms, examples of which may include a desktop computer, a laptop, a netbook, a tablet, a smartphone, and/or a personal digital assistant (PDA), among other possibilities. Further, the one or more end-user devices may be associated with various types of users, including consumers of banking institutions, among other examples in accordance with the discussion above.

Each communication path between the back-end computing platform and an end-user device may generally comprise one or more communication networks and/or communications links, which may take any of various forms. For instance, each respective communication path may comprise any one or more of point-to-point links, Personal Area Networks (PANs), Local-Area Networks (LANs), Wide-Area Networks (WANs) such as the Internet or cellular networks, cloud networks, and/or operational technology (OT) networks, among other possibilities. Further, the communication networks and/or links that make up each respective communication path may be wireless, wired, or some combination thereof, and may carry data according to any of various different communication protocols. Although not shown, the respective communication paths may also include one or more intermediate systems. For example, it is possible that the back-end computing platform may communicate with a given end-user device via one or more intermediary systems, such as a host server (not shown). Many other configurations are also possible.

The back-end computing platform may also be configured to receive data from one or more external data sources that may be used to facilitate the functionality disclosed herein. For example, the back-end computing platform may be configured to image data from a third-party data source. Other examples are also possible. Further, the back-end computing platform may also be configured to communicate with one or more other computing platforms, such as a back-end computing platform associated with a banking institution in order to facilitate transfer of funds. Other examples are also possible.

In one implementation, the example functionality 1000 may be carried out in a computing environment such as the computing environment 400 discussed above with reference to FIG. 4. In such an implementation, the example functionality 1000 may be carried out by the back-end computing platform 401, which may communicate with one or more end-user devices 402 via respective communication paths 403 in accordance with the discussion above.

The example functionality 1000 may begin at 1002, where the back-end computing platform may obtain image data corresponding to an image of a physical artifact (e.g., a bank check). In practice, the process of obtaining image data may involve receiving an image of the physical artifact. For instance, in accordance with the discussion above, a consumer of a financial institution may use an end-user device (e.g., a smartphone) to access a banking software application that is hosted by the back-end computing platform and may capture an image of a physical bank check using a camera of the end-user device, which may be provided to the back-end computing platform via the software application in the form of black-and-white pixelized image data corresponding to the physical artifact.

At 1004, the back-end computing platform may identify a set of contours in the image based on the image data. At 1006, the back-end computing platform may sort the identified contours into one or more groups. For instance, in one implementation, the contours may be sorted by size into a first group comprising contours of a first size, a second group comprising contours of a second size, and a third group comprising contours of a third size. In accordance with the discussion above, one or more of the groups may be discarded from further analysis. For instance, a given group of contours, such as the first group, may comprise contours that do not meet a minimum size threshold and may thus be discarded from further analysis.

At 1008, the back-end computing platform may process a given group of contours in order to identify an array of lines each comprising a respective set of contours. For instance, in accordance with the discussion above, a given group of contours, such as the second group, may comprise contours that fall within a threshold contour size range. As discussed above, the second group of contours may be evaluated to determine a given line to which each contour in the second group is to be allocated.

After identifying an array of lines each comprising a respective set of contours, at 1010, the back-end computing platform may process a given group of contours in order to identify additional contours that should be included in the array of lines. For instance, a given group of contours, such as the third group of contours, may comprise contours that exceed a maximum size threshold and intersect at least one line in the array of lines. In accordance with the discussion above, the third group of contours may be processed to include, for each respective line in the array of lines, additional contours that intersect the respective line.

After the additional contours from the given group have been added to the array of lines, at 1012, the back-end computing platform may evaluate the respective set of contours for each respective line in order to group the contours of the respective line into individual characters, in accordance with the discussion above.

After individual characters have been identified for each line in the array of lines for the image, at 1014, the back-end computing platform may perform one or more character recognition techniques in order to identify each individual character in the image.

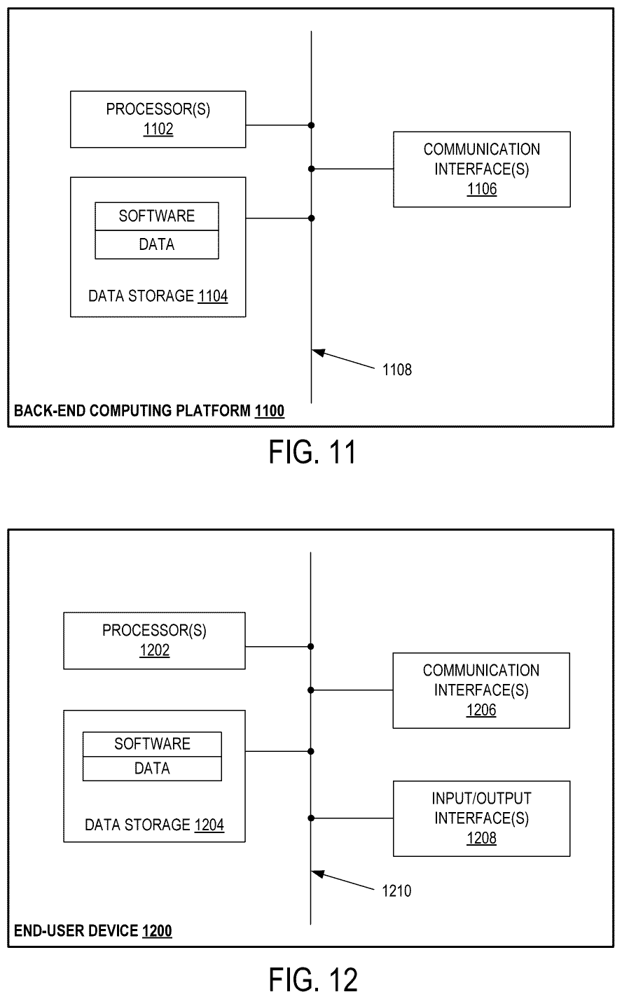

Turning now to FIG. 11, a simplified block diagram is provided to illustrate some structural components that may be included in an example back-end computing platform 1100 that may be configured to carry out any of the various back-end platform functions disclosed herein. At a high level, the example back-end computing platform 1100 may generally comprise any one or more computing systems that collectively include one or more processors 1102, data storage 1104, and one or more communication interfaces 1106, all of which may be communicatively linked by a communication link 1108 that may take the form of a system bus, a communication network such as a public, private, or hybrid cloud, or some other connection mechanism. Each of these components may take various forms.

The one or more processors 1102 may each comprise one or more processing components, such as general-purpose processors (e.g., a single-or a multi-core central processing unit (CPU)), special-purpose processors (e.g., a graphics processing unit (GPU), application-specific integrated circuit, or digital-signal processor), programmable logic devices (e.g., a field programmable gate array), controllers (e.g., microcontrollers), and/or any other processor components now known or later developed. It should also be understood that the one or more processors 1102 could comprise processing components that are distributed across a plurality of physical computing systems connected via a network.

In turn, the data storage 1104 may comprise one or more non-transitory computer-readable storage mediums that are collectively configured to store (i) program instructions that are executable by one or more processors 1102 such that the back-end computing platform 1100 is configured to perform any of the various functions disclosed herein, including but not limited to any of the back-end-platform functions disclosed herein, and (ii) data that may be received, derived, or otherwise stored, for example, in one or more databases, file systems, repositories, or the like, by the back-end computing platform 1100, in connection with performing any of the various back-end platform functions disclosed herein. In this respect, the one or more non-transitory computer-readable storage mediums of the data storage 1104 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. It should also be understood that the data storage 1104 may comprise computer-readable storage mediums that are distributed across a plurality of physical computing systems connected via a network.

The one or more communication interfaces 1106 may be configured to facilitate wireless and/or wired communication with other systems and/or devices. Additionally, in an implementation where the back-end computing platform 1100 comprises a plurality of physical computing systems connected via a network, the one or more communication interfaces 1106 may be configured to facilitate wireless and/or wired communication between these physical computing systems (e.g., between computing and storage clusters in a cloud network). As such, the one or more communication interfaces 1106 may each take any suitable form for carrying out these functions, examples of which may include an Ethernet interface, a serial bus interface (e.g., Firewire, USB 3.0, etc.), a chipset and antenna adapted to facilitate wireless communication, and/or any other interface that provides for any of various types of wireless communication (e.g., Wi-Fi communication, cellular communication, short-range wireless protocols, etc.) and/or wired communication. Other configurations are possible as well.

Although not shown, the back-end computing platform 1100 may additionally include or have an interface for connecting to one or more user-interface components that facilitate user interaction with the back-end computing platform 1100, such as a keyboard, a mouse, a trackpad, a display screen, a touch-sensitive interface, a stylus, a virtual-reality headset, and/or one or more speaker components, among other possibilities.

It should be understood that the back-end computing platform 1100 is one example of a computing platform that may be used with the embodiments described herein. Numerous other arrangements are possible and contemplated herein. For instance, in other embodiments, the back-end computing platform 1100 may include additional components not pictured and/or more or fewer of the pictured components.

Turning to FIG. 12, a simplified block diagram is provided to illustrate some structural components that may be included in an example end-user device 1200 that may be configured to carry out any of the various functions disclosed herein, including but not limited to any of the various end-user device functionality discussed above, including any functionality carried out by a content consumer end-user device or a content designer end-user device. As shown in FIG. 12, the end-user device 1200 may include one or more processors 1202, data storage 1204, one or more communication interfaces 1206, and one or more input/output (I/O) interfaces 1208, all of which may be communicatively linked by a communication link 1110 that may take the form of a system bus or some other connection mechanism. Each of these components may take various forms.

The one or more processors 1202 may comprise one or more processing components, such as general-purpose processors (e.g., a single-or a multi-core CPU), special-purpose processors (e.g., a GPU, application-specific integrated circuit, or digital-signal processor), programmable logic devices (e.g., a field programmable gate array), controllers (e.g., microcontrollers), and/or any other processor components now known or later developed.

In turn, the data storage 1204 may comprise one or more non-transitory computer-readable storage mediums that are collectively configured to store (i) program instructions that are executable by the processor(s) 1202 such that the end-user device 1200 is configured to perform any of the end-user device functions disclosed herein, and (ii) data that may be received, derived, or otherwise stored, for example, in one or more databases, file systems, repositories, or the like, by the end-user device 1200. In this respect, the one or more non-transitory computer-readable storage mediums of the data storage 1204 may take various forms, examples of which may include volatile storage mediums such as random-access memory, registers, cache, etc. and non-volatile storage mediums such as read-only memory, a hard-disk drive, a solid-state drive, flash memory, an optical-storage device, etc. The data storage 1204 may take other forms and/or store data in other manners as well.

The one or more communication interfaces 1206 may be configured to facilitate wireless and/or wired communication with other computing devices. The communication interface(s) 1206 may take any of various forms suitable to provide for any of various types of wireless communication (e.g., Wi-Fi communication, cellular communication, short-range wireless protocols, etc.) and/or wired communication. Other configurations are possible as well.

The end-user device 1200 may additionally include or have interfaces for one or more I/O interfaces 1208 that can be used to facilitate user interaction with the end-user device 1200, such as a keyboard, a mouse, a trackpad, a display screen, a touch-sensitive interface, a stylus, a virtual-reality headset, and/or one or more speaker components, among other possibilities.

It should be understood that the end-user device 1200 is one example of an end-user device that may be used to interact with an example computing platform as described herein. Numerous other arrangements are possible and contemplated herein. For instance, in other embodiments, the end-user device 1200 may include additional components not pictured and/or more or fewer of the pictured components.

### CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. Claims should not be construed as requiring action by such actors unless explicitly recited in claim language.

1. A computing platform comprising:
at least one processor;
at least one non-transitory computer-readable medium; and
program instructions stored on the at least one non-transitory computer-readable medium that are executable by the at least one processor such that the computing platform is configured to:
receive, from a computing device associated with a given user, image data corresponding to an image of a physical artifact;
analyze the image data to identify contours present in the image;
sort the contours into mutually exclusive groups, wherein a first group of contours is discarded from further analysis;
evaluate a second group of contours and thereby identify respective locations of lines in an array of lines in the image, wherein each line comprises a respective set of contours from the second group of contours that have a similar y-axis value within the image;
evaluate a third group of contours and thereby add additional contours to the array of lines, wherein each contour in the third group intersects a given line in the array of lines;
for each line in the array of lines, group the line's respective set of contours into individual characters; and
apply one or more character recognition techniques and thereby output a recognized character for each individual character in each line.

2. The computing platform of claim 1, wherein the image was captured using a camera of the computing device.

3. The computing platform of claim 1, wherein the image was captured using a camera of the computing device, and wherein the physical artifact comprises a physical bank check.

4. The computing platform of claim 1, wherein the program instructions that are executable by the at least one processor such that the computing platform is configured to analyze the image data to identify contours present in the image comprise program instructions that are executable by the at least one processor such that the computing platform is configured to:
identify each continuous set of pixels in the image data as a respective contour.

5. The computing platform of claim 1, wherein the program instructions that are executable by the at least one processor such that the computing platform is configured to sort the contours into mutually exclusive groups comprise program instructions that are executable by the at least one processor such that the computing platform is configured to:
establish a contour size baseline comprising a minimum size threshold and a maximum size threshold;
identify contours that do not meet minimum size threshold as the first group of contours;
identify contours that fall within the minimum size threshold and the maximum size threshold as the second group of contours; and
identify contours that exceed the maximum size threshold as the third group of contours.

6. The computing platform of claim 5, wherein the minimum size threshold comprises a minimum possible size of any given contour for a given character font presented in the physical artifact.

7. The computing platform of claim 5, wherein the maximum size threshold comprises a maximum possible size of any given contour for a given character font presented in the physical artifact.

8. The computing platform of claim 1, wherein the program instructions that are executable by the at least one processor such that the computing platform is configured to evaluate the second group of contours and thereby identify the respective locations of each of the array of lines in the image comprise program instructions that are executable by the at least one processor such that the computing platform is configured to:
scan the image from a first edge to a second edge; and
while scanning the image:
identify a first contour;
draw a first bounding box enclosing the first contour and thereby locate a first line comprising the first contour;
identify an additional contour;
draw a projected box enclosing the additional contour, wherein the projected box is extended vertically around the additional contour by a threshold amount; and
extend the projected box laterally in a left-ward direct to identify any preceding contours having a respective line to which the additional contour may be added.

9. The computing platform of claim 8, further comprising program instructions that are executable by the at least one processor such that the computing platform is configured to:
after identifying the additional contour, while extending the projected box laterally, determine that the projected box overlaps the first bounding box enclosing the first contour;
based on determining that the projected box overlaps the first bounding box enclosing the first contour, determine that the additional contour is to be added to the first line; and
add the additional contour to the first line.

10. The computing platform of claim 8, further comprising program instructions that are executable by the at least one processor such that the computing platform is configured to:
after identifying the additional contour, while extending the projected box laterally, determine that the projected box overlaps (i) the first bounding box enclosing the first contour and (i) a second bounding box enclosing a second contour in a second line;
based on one or both of (i) a respective amount of overlap between the projected box and each of the first and second contours or (ii) a respective proximity between the additional contour and each of the first and second contours, determine that the additional contour is to be added to the second line instead of the first line; and
add the additional contour to the first line.

11. The computing platform of claim 1, wherein the program instructions that are executable by the at least one processor such that the computing platform is configured to evaluate the third group of contours and thereby add additional contours to the array of lines comprise program instructions that are executable by the at least one processor such that the computing platform is configured to:
for each contour in the third group that intersects a given line in the array of lines:
determine at least one of a first portion that extends vertically beyond an upper boundary of the given line or a second portion that extends vertically beyond a lower boundary of the given line;
determine a third portion that fits within the upper and lower boundaries of the given line;
discard the first and second portions; and
add the third portion to the given line.

12. The computing platform of claim 1, wherein the program instructions that are executable by the at least one processor such that the computing platform is configured to for each line in the array of lines, group the line's respective set of contours into individual characters comprise program instructions that are executable by the at least one processor such that the computing platform is configured to, for each line in the array of lines:
begin scanning the line;
identify a beginning of a first contour in the respective set of contours;
based on identifying the beginning of the first contour, begin adding the first contour to a buffer; and
identify an end of the first contour.

13. The computing platform of claim 12, further comprising program instructions that are executable by the at least one processor such that the computing platform is configured to:
make a first determination that the end of the first contour is reached and that a minimum character area has not been reached;
based on the first determination, make a second determination that the first contour is to be grouped as an individual character; and
based on the second determination:
draw a bounding box enclosing the first contour;
clear the buffer; and
continue scanning the line.

14. The computing platform of claim 12, further comprising program instructions that are executable by the at least one processor such that the computing platform is configured to:
make a first determination that the end of the first contour is reached and that a minimum character area has not been reached;
based on the first determination, continue scanning the line;
identify a beginning of a second contour in the respective set of contours;
make a second determination that the minimum character area has not been reached and a maximum contour distance has not been reached;
based on the second determination, begin adding the second contour to the buffer;
while scanning the second contour, make a third determination that the minimum character area has been reached and the maximum contour distance has not been reached;
based on the third determination, make a fourth determination that that the first contour and the second contour are to be grouped as an individual character; and
based on the fourth determination:
draw a bounding box enclosing the first and second contours;
clear the buffer; and
continue scanning the line.

15. A non-transitory computer-readable medium, wherein the non-transitory computer-readable medium comprises program instructions that, when executed by at least one processor, cause a computing platform to:
receive, from a computing device associated with a given user, image data corresponding to an image of a physical artifact;
analyze the image data to identify contours present in the image;
sort the contours into mutually exclusive groups, wherein a first group of contours is discarded from further analysis;
evaluate a second group of contours and thereby identify respective locations of lines in an array of lines in the image, wherein each line comprises a respective set of contours from the second group of contours that have a similar y-axis value within the image;
evaluate a third group of contours and thereby add additional contours to the array of lines, wherein each contour in the third group intersects a given line in the array of lines;
for each line in the array of lines, group the line's respective set of contours into individual characters; and
apply one or more character recognition techniques and thereby output a recognized character for each individual character in each line.

16. The non-transitory computer-readable medium of claim 15, wherein the image was captured using a camera of the computing device.

17. The non-transitory computer-readable medium of claim 15, wherein the image was captured using a camera of the computing device, and wherein the physical artifact comprises a physical bank check.

18. The non-transitory computer-readable medium of claim 15, wherein the program instructions that, when executed by at least one processor, cause the computing platform to analyze the image data to identify contours present in the image comprise program instructions that, when executed by at least one processor, cause the computing platform to:
identify each continuous set of pixels in the image data as a respective contour.

19. The non-transitory computer-readable medium of claim 15, wherein the program instructions that, when executed by at least one processor, cause the computing platform to sort the contours into mutually exclusive groups comprise program instructions that, when executed by at least one processor, cause the computing platform to:
establish a contour size baseline comprising a minimum size threshold and a maximum size threshold;
identify contours that do not meet minimum size threshold as the first group of contours;
identify contours that fall within the minimum size threshold and the maximum size threshold as the second group of contours; and
identify contours that exceed the maximum size threshold as the third group of contours.

20. A method carried out by a computing platform, the method comprising:
receiving, from a computing device associated with a given user, image data corresponding to an image of a physical artifact;
analyzing the image data to identify contours present in the image;
sorting the contours into mutually exclusive groups, wherein a first group of contours is discarded from further analysis;
evaluating a second group of contours and thereby identify respective locations of lines in an array of lines in the image, wherein each line comprises a respective set of contours from the second group of contours that have a similar y-axis value within the image;
evaluating a third group of contours and thereby add additional contours to the array of lines, wherein each contour in the third group intersects a given line in the array of lines;
for each line in the array of lines, grouping the line's respective set of contours into individual characters; and
applying one or more character recognition techniques and thereby output a recognized character for each individual character in each line.
